(19) United States
(12) Patent Application Publication
(10) Pub. No.: US 2008/0168926 A1
(43) Pub. Date: Jul. 17, 2008

(54) Pavement

(75) Inventors: Renate Muller, Berlin (DE); Stephan Pirskawetz, Berlin (DE); Christoph Recknagel, Berlin (DE); Ernst-Joachim Vater, Berlin (DE); Frank Weise, Berlin (DE)

Correspondence Address: NORRIS, MCLAUGHLIN & MARCUS, P.A., 875 THIRD AVE, 18TH FLOOR, NEW YORK, NY, 10022, US

(73) Assignees: Takeji Hotta, Aichi (JP); BAM Bundestanstalt fuer Materialforschung und-prun, Berlin (DE)

(21) Appl. No.: 11/570,696

(22) PCT Filed: Dec. 21, 2004
(86) PCT No.: PCT/JP04/19076

§ 371 Date: Jul. 24, 2007

(30) Foreign Application Priority Data
Jun. 16, 2004 (DE) 10 2004 029 869.6

(51) Int. Cl. C08K 3/34; C04B 14/06; E01C 3/00

(52) U.S. Cl. 106/668; 524/59; 404/31

(57) ABSTRACT

Asphalt pavement exhibiting high reflectivity, heat transmittance and improved thermo-mechanical properties.

### TECHNICAL FIELD

The present invention relates to a road pavement (roadway surface layer), especially, it relates to an asphalt road pavement for car traffic.

### BACKGROUND ART

Today's road pavement structures are composed of a road bed which is artificially heaped up and compressed (embankment-like construction), and a layered upper structure consisting of a sub-base layer and a roadway surface layer. The roadway surface layer has the function to provide a durable roadworthy and trafficable surface for the traffic, and to protect the sub-base layer underneath thereof from the direct impact of weather and traffic. In close interconnection with the sub-base layer, the roadway surface layer contributes to the bearing capacity of the whole construction. Basically, asphalt surfaces, concrete surfaces and paved surfaces are distinguished, wherein in the present application, only asphalt surfaces are of particular interest. The roadway surface layer itself usually consists of an upper surface layer at the top and a binding layer being disposed between a base layer and the upper surface layer. At present according to DIN55946 (German standard 55946), it is understood that asphalt means “a natural or industrially produced mixture of bitumen or a bitumen-containing binding material and mineral matters and, if applicable, other aggregates and/or additives”. The phrase bitumen denotes high molecular hydrocarbon mixtures obtained as residues in the distillation of raw oil. Bitumen exists as a colloidal dispersed biphasic system of solid asphaltenes and viscous oil and is generally dark-colored. In addition, synthetic binding materials also may be used for the production of asphalts. The term “binding material” is used as generic term for bitumen, bitumen-containing binding materials and synthetic binding materials.

### DISCLOSURE OF THE INVENTION

### Problems to be Solved by the Invention

Depending on the climatic conditions and the traffic volume, road pavements are exposed to thermal and mechanical stress, which may lead to different damage patterns. For instance, the heating of the roadway surface caused by solar irradiation and by high air temperatures leads to plastification of the binding materials, which can cause, in combination with the mechanical traffic stress, a formation of lane ruts. In addition, in regions being pre-damaged in this way, longitudinal cracks can occur in case of concurrent winterly cooling and high mechanical loads. Both, thermal and mechanical burdens increasingly appear in large cities. On one hand, a situation known as “heat island phenomenon” occurs in large cities, characterized in that, on hot summer days, the temperature in urban areas is considerably higher than in the surrounding rural areas. This phenomenon is caused by different factors including increased heat emission by industry and motor vehicles; storage of irradiated heat by buildings; reduction of convective heat dissipation by wind as a result of dense buildings, and of a decreased natural cooling via water evaporation due to fewer green spaces. From a mechanical point of view, high traffic volumes, a decreased average speed as well as interruptions in traffic flow have a particularly negative impact in this respect. The same effect results from increasing axle loads.

From a thermal point view, the heat balance of the roadway surface is of particular importance for the rut formation. The incoming heat flow consists of two components: a short-wave heat flow component as a result of directed and diffuse solar radiation and a long-wave heat flow component due to atmospheric back-radiation. Depending largely on the reflectance of the road surface (the so called Albedo), parts of the short-wave radiation are reflected, while the other part is absorbed. On the other hand, almost irrespective of the nature of the roadway surface, most of the incoming long-wave heat flow component is absorbed with an absorption coefficient of about 0.95. Both, the short-wave and long-wave heat flow components absorbed by the roadway surface (minus the heat flows given back off into the atmosphere due to convection and self-radiation) are then conducted into the inner parts of the roadway structure. Besides to the respective road construction and the thermal boundary conditions, heat dissipation will be determined largely by the thermal conductivity and the heat storage capacity of the individual pavement layers and the sub-base. In principle, while heat is being transported from the roadway surface to the ground water, a part of the inducted heat flow will be stored in the respective pavement layer, while the remaining part is passed to the next layer beneath. A suitable assessment criterion for the complex thermal evaluation of the individual pavement layers and of the sub-base is the heat penetration coefficient b, which is expressed as b=(λ×ρ×cₚ)^{1/2} where λ is the thermal conductivity, ρ is the dry maximum specific density or the bulk density and cₚ is the specific heat capacity. Accordingly, the material characteristics leading to a strong heating are a low reflectivity (low albedo) of the surface layer and a low heat penetration of the individual construction layers of the roadway.

From a thermo-mechanical point of view, a small flexural stiffness of the construction comprising the surface layer and the binding layer, and high and deviating thermal expansion coefficients of the construction materials and mixtures thereof cause many known damage patterns.

For decreasing the surface temperature of the road pavement, active systems are known, which convectively lead off the heat inducted into the roadway by built-in water-bearing pipes. However, these systems require high investment costs and special geological conditions. In contrast to this, passive systems aim to reduce the amount of energy penetrating the road pavement and/or aim to improve the thermo-mechanical properties of the surface layer and the binding layer. Herein, different surface treatments are considered, such as painting, surface coating or strewing. The painting with specially developed painting materials is disadvantageous because of it's low wear resistance under traffic load. The same disadvantage appears for surface coatings. For example, it is known to apply an 8 to 10 mm thick porcelain layer on the roadway surface layer. However, disadvantages of this solution are the low thermal transmission and the low adhesion strength between the surface coating and the layers beneath as well as large differences in the stiffness compared to these layers.

Besides the above surface treatments of the surface layer, modifications of the components of the surface layer are considered. In this connection, particularly the employment of light-colored mineral matters in the surface layer is known. As light mineral matter, for example, burnt flint, Taunus-quartzite, light-colored granites, light-colored granodiorites and moraines are known. The brightness of the surface layer naturally increases with the ratio of the light-colored mineral matters contained in the entire mining stones. However, since known light-colored mineral matters have a lower impact resistance, the main part of the used mineral matters is often made up of dark-colored impact-resistant mineral matters, so that the brightening effect is partially compensated. As an example, it is known to select 50 M-% of the finer and medium chipping grades of light-colored mineral matters and the remaining 50 M-% and the course chippings of dark-colored impact-resistant mineral matters. Moreover, it is discussed to use light-stainable binding materials, where applicable in combination with light-colored mineral matters.

The problem of the invention to be solved is to provide a road pavement of the asphalt type showing the properties of high reflectance and heat permeability and, at the same time, improved thermo-mechanical characteristics. The road pavement should be durable particularly in highest traffic loads.

### Means to Solve the Problem

This problem is solved by the road pavement having the characteristics referred in claim 1. According to the present invention, the road pavement has at least one asphalt layer, in particular an upper surface layer and/or a binding layer disposed underneath, containing a mixture of at least one mineral matter and at least one binding material, wherein at least 60 M-% of the mineral matter of the at least one asphalt layer is crystalline quartz. According to ISO 1109, crystalline quartz contains at least 93 M-% of SiO₂, besides typical associated products such as feldspars, layered silicates, heavy metals, iron and manganese minerals, broken rock pieces and the like, and has a melting temperature of at least 1500° C. Moreover, crystalline quartz has a heat conductivity of about 10.5 W/(mK) which is about 2 or 3 times higher than that of conventional mineral matters used in the past in road constructions. In combination with a specific heat capacity Cₚ of about 720 J/(kgK) the high heat conductivity leads to a high heat permeability. Thus, the crystalline quartz, which is in particular applied in the surface layer as well as in the binding layer disposed below the surface layer, allows a very effective heat dissipation of the absorbed heat energy into the respective roadway construction layers disposed there under. Moreover, crystalline quartz is a very light-colored mineral matter having a high reflection capability. For example, the albedo of crystalline quartz is about 3 to 4 times higher than that of light-colored granite. Due to the high reflection capability, the absorbed fraction from the incident solar irradiation is very strongly reduced. At the same time, crystalline quartz shows excellent thermo-mechanical properties. For instance, it is one of the hardest natural materials (Mohs hardness 7, specific weight 2.65 g/cm³). Crystalline quartz has a trigonal trapezohedron crystal structure. Another advantage of crystalline quartz is based on it's very low thermal expansion coefficient of about 1×10⁻⁶ K⁻¹, which is about a power of 10 smaller than that of conventional road construction stones such as basalt, granite or limestone. The low thermal expansion coefficient dramatically reduces the heat expansion of the corresponding pavement layer, leading in turn to a significant reduction of thermally induced stress and crack formation. Thus, crystalline quartz combines favorable thermodynamic and thermo-mechanical properties, altogether resulting in a highly durable and cold-contacting asphalt roadway pavement having a high reflection capability.

The excellent mechanical properties of crystalline quartz permit it's application with high weight percentages. Thus, according to a preferred embodiment of this invention, at least 90%, particularly at least 95%, preferably 97 M-% of the mineral matter applied in the respective asphalt layer is crystalline quartz. It is particularly preferred to exclusively employ crystalline quartz as mineral matter, apart from added inorganic pigments if applicable (as shown below).

The quartz is preferably employed in the form of crystalline crashed quartz, particularly, in form of mixtures of at least one quartz high quality chippings and at least one quartz high quality crushed sand and quartz dust, in order to achieve optimal grain size distributions.

According to a preferred embodiment of this invention, the grain size distribution of the mineral matter of the surface layer, particularly of the crystalline quartz, is 0 to 8 mm. In such a case, it is particularly preferred that the mineral matter of the surface layer (possibly including pigments in powder form added for lighting the color) has the following grain size distribution: 70-80 M-%, particularly about 75 M-% correspond to a grain size distribution of 2 to 8 mm; 8-18 M-%, particularly about 13 M-% correspond to a grain size distribution of 0.09 to 2 mm; and 7-17 M-%, particularly about 12 M-% correspond to a grain size distribution of 0 to 0.09 mm.

On the other hand, the mineral matter of the binding layer preferably has a grain size distribution of 0 to 16 mm. In particular, the mineral matter of the binding layer has the following grain size distribution: 70-80 M-%, particularly about 73 M-% correspond to a grain size distribution of 2 to 16 mm; 15-30 M-%, particularly about 21 M-% correspond to a grain size distribution of 0.09 to 2 mm; and 3-10 M-%, particularly about 6 M-% correspond to a grain size distribution of 0 to 0.09 mm.

Particular embodiments of the grain size distribution are shown in the present Examples below. The mentioned grain size distributions of the surface layer and the binding layer are a result of manifold aptitude tests in laboratories followed by complex thermodynamic and thermo-mechanical model calculations, they are optimized in terms of the bending strength. The above grain size distributions differ from that of German road construction provisions (“Richtlinien für die Standardisierung des Oberbaus von Verkehrsflächen” (Guideline for the standardization of the upper structure of traffic surfaces), RStO) in several points.

Another important aspect of the development works resulting in this invention tends to optimize the thickness of the surface and binding layer. According to the present invention, a mean mounting thickness of the surface layer is 2.0 to 3.0 cm, particularly, about 2.5 cm, and a mean mounting thickness of the binding layer is 8.5 to 11.0 cm, particularly, about 9.5 cm. In this connection, the total mounting thickness of both layers is preferred to be about 12 cm. On the other hand, German RStO recommends, for strongly exposed roadway surface layers, an asphalt binding layer having a thickness of 8 cm and an asphalt surface layer having a thickness of 4 cm. In general, RStO specifies the thickness of binding layers of 5.0 to 8.5 cm. According to the present invention, the thickness of the asphalt binding layer having a high bending rigidity is increased, at cost of the less bending-rigid asphalt surface layer. As a result, the flexural rigidity of the roadway pavement becomes significant higher than that of known concepts. Particularly the combination with the use of crystalline quartz as mineral matter in the layers results in very high stabilities of the road pavement, which thus becomes suitable for highest traffic loads.

Another important aspect of the present invention can be seen in the optimization of the employed binding materials. In this connection, it is particularly preferred to employ as binding material in the binding layer and/or in the surface layer a polymer-modified bitumen and/or a polymer-modified synthetic binding material. These are binding materials in which special polymers are added. In case of so-called ready-to-use polymer-modified bitumen, the polymer is incorporated into the binding materials at the refinery. Preferably, the binding layer contains a polymer-modified bitumen of the PmB25A type and the surface layer contains a PmB of type PmB45A or a binding material that can be stained in a light color (shown in the following). The terms used herein correspond to the (German) technical delivery conditions of ready-to-use polymer-modified bitumen issued in 2001 (“Technische Lieferbedingungen für gebrauchsfertige polymer-modifizierte Bitumen”, TL-PmB2001). Therein, lower characteristic values in the denomination correspond to higher rigidities. By employing polymer-modified bitumen/binding materials, the road pavement of this invention gains a high elasticity modulus (resilient modulus) and a small plastic deformability of the individual layers. In addition, the norm values of the PmB25A and PmB45A type according to TL-PmB2001 are shown below in Tables 10 and 11 along with typical values of the materials used in the Examples.

When the surface layer is produced with a dark-colored polymer-modified bitumen, it is further preferred that the surface layer is subsequently treated by an erosive surface treatment that removes a film of binding material, for example, by sandblasting. In this way, the light-colored quartz material is uncovered for increasing the brightness. By this method, the reflectivity of the surface layer can be raised from 0.05 to 0.17.

According to an alternative, even more preferred embodiment, a light-colored, transparent, semi-transparent and/or a binding material stainable with light-colored pigments is used in the surface layer. Preferably, a semi-transparent polymer-modified binding material is used for the surface layer, which is stained by addition of light-colored pigments, especially of titanium dioxide TiO₂. In interaction with crystalline quartz, such a surface layer has a reflection coefficient of 0.26 or more. On the other hand, the surface layer of conventional asphalt roadways have a reflection coefficient of 0.05 to 0.10.

According to another preferred embodiment of this invention, at least one of the asphalt layers, but specifically the surface layer, contains a stabilizing additive. The stabilizing additive may be, for example, cellulose fibers and/or a filled polyolefine, and is in case of the binding layer preferably a filled polyolefine.

For the surface layer a void content is aimed at ranging from 1.0 to 6.0 V-%, particularly from 2.0 to 5.0, preferably from 3.0 to 4.0 V-%. On the contrary, a void content tending to higher values is advantageous for the binding layer. Particularly, here a void content is adjusted of 2.0 to 9.0 V-%, preferably of 3.0 to 8.0, and particular preferably of 4.0 to 7.0 V-%.

A particular preferred surface layer according to the present invention has the following composition: 6.0 to 8.0 M-% of at least one stainable polymer-modified binding material, 80 to 95 M-% of crystalline crushed quartz, 0.3 to 2.0 M-% of at least one stabilizing additive, and 0.1 to 3.0 M-% (related to the mineral matter content) of a white inorganic pigment.

According to an alternative embodiment, the surface layer has the following composition: 6.0 to 8.0 M-% of at least one polymer-modified binding material, 80 to 95 M-% of crystalline crushed quartz, and 0.3 to 2.0 M-% of at least one stabilizing additive. In this variant, the surface of the surface layer is processed by an erosive treatment which removes a film of the binding material.

A preferred binding layer according to the present invention has the following composition: 3.5 to 6.0 M-% of a polymer-modified binding material and 94 to 96.5 M-% of crystalline crushed quartz.

The above details apply accordingly for the grain size distribution of the crystalline crushed quartz, the polymer-modified binding materials to be employed, possible additives in the surface layer, and the layer thickness of the surface layer and binding materials.

Further advantageous embodiments of this invention are the subject-mater of the remaining depending claims.

Effect of this Invention

The road pavement of this invention comprises at least one asphalt layer (12, 14) containing a mixture of at least one mineral matter (16, 22) and at least one binding material (18, 24), wherein at least 60 M-% of the mineral matter (16, 22) of at least one asphalt layer (12, 14) is crystalline quartz. Accordingly, the pavement shows effects including a high reflection capability and a high thermal conductivity, and at the same time, it shows improved thermo-mechanical properties.

### Best Mode for Carrying Out the Invention

### BRIEF DESCRIPTION OF DRAWING

In the following, preferred embodiments of this invention are described in more detail with reference to the corresponding figures.

FIG. 1 shows the construction of a road pavement according to this invention.

FIG. 2 shows a grain size distribution curve of the mineral matter of the binding layer.

FIG. 3 shows a grain size distribution curve of the mineral matter of the surface layer.

FIG. 4 shows a graph representing the results of a temperature measurement test.

FIG. 5 shows a graph representing the results of a temperature measurement test.

### EXAMPLE 1

Example 1 includes Examples 1-1 to 1-3. Since the working steps of examples 1-1 to 1-3 have many common parts, these steps are explained together. Production of an asphalt binding layer and a surface layer from stone mastic asphalt The road pavement according to this invention is a 2-layered roadway surface layer, which is paved on an existing sub-base layer by techniques and machines commonly used in road construction.

The asphalt mixture for the surface layer and the binding layer is produced in drying and mixing equipments. The following operation steps are conducted therein:
Pre-dosing of the mineral matters;
Drying and heating of the mineral matters at about 175° C.;
Sieving, intermediate storing and dosing of the hot mineral matters;
Addition of the stone dust;
Addition of stabilizing additives (cellulose fibers, PR-Plast.S);
Premixing of the mineral matters and the stabilizing additives in a main mixing drum;
Dosing and premixing of the binding material heated at about 175° C. and of titanium dioxide (only in case of light-colored surface layer) in a separate mixing drum;
Addition of the heated and, if applicable, premixed binding material in the main mixing drum;
Mixing; and, if applicable
Intermediate storing of the mixture in a silo.

The installed mixing capacity is usually between 120 and 300 t/h. The transport capacity to be provided should be adjusted according to the capacity of the mixing facility, to the mounting efficiency of the road finisher, to the transport distance and the traffic situation. The ready-mix should be transported covered and, if possible, in thermally insulated containers. In principle, the ready-mix should be paved using road finishers. A sufficient high mounting temperature is a precondition for a correct compression and a good layer binding. The compression begins by pre-compression with a mounting deal board of the road finisher. For roller compression, static smooth wheel rollers, vibration rollers and/or gum tire rollers can be used.

The composition and several asphalt properties of the binding layer are shown in Table 1 (Example 1-1). The composition and material properties of a stone mastic asphalt having light-color stained binding material are shown in Table 2 (Example 1-2). The composition and material properties of an alternative stone mastic asphalt having dark binding materials obtained by applying an abrasive surface treatment is summarized in Table 3 (Example 1-3). In these tables, “total weight” means the total weight of the minerals.

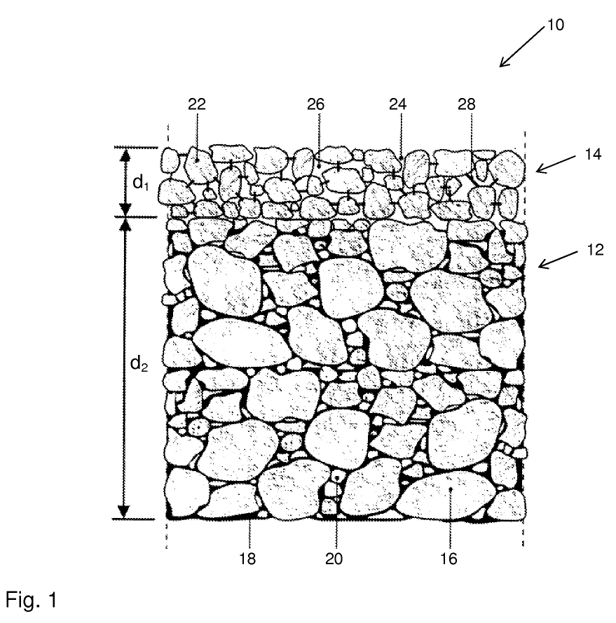

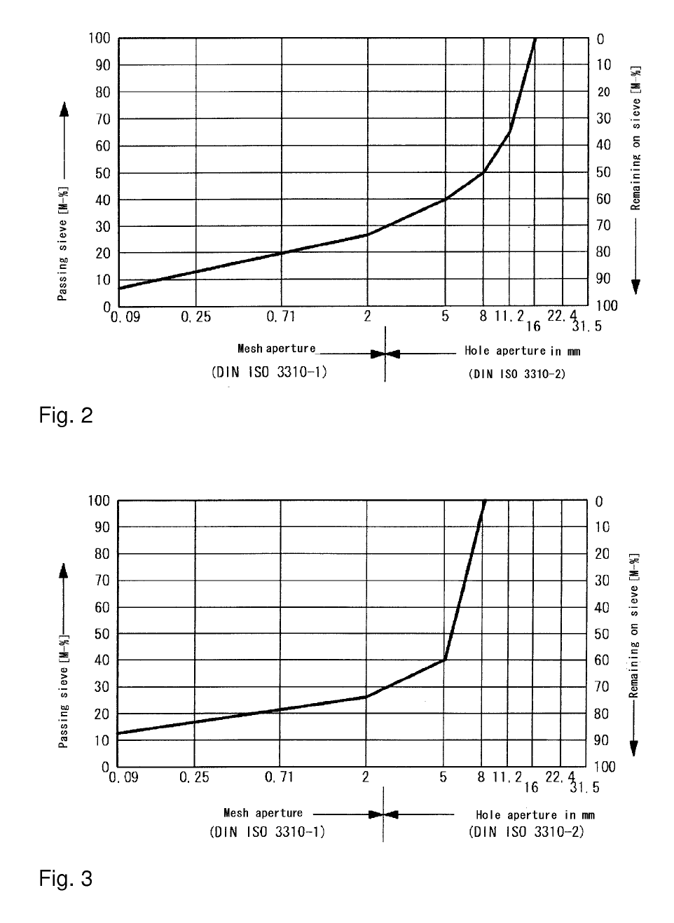

FIG. 1 schematically shows a cross-section of the structure of a road pavement according to this invention. The pavement collectively designated by reference number 10, comprises an asphalt binding layer 12 having an average paving thickness d₂ of 9.5 cm and a surface layer 14 disposed thereon of stone mastic asphalt having a paving thickness d₁ of 2.0-3.0 cm. The mineral matter 16 used in the binding layer 12 is exclusively crystalline crushed quartz having a grain size distribution ranging from 0 to 16 mm. The grain size distribution curve of the mineral matter 16 of the binding layer 12 is shown in FIG. 2. The binding material 18 used in the binding layer 12 is polymer-modified bitumen of the type PmB25A having the trade name Caribit 25 (Company: Deutsche Shell GmbH) (shown in Table 10). Hitherto, this binding material had not entered into German rules for roadway surface layers of asphalt. The void 20 occupies 2.0-8.0 V-% of the binding layer 12.

The shown surface layer 14 (according to Table 2) likewise contains crystalline crushed quartz as mineral matter 22. The grain size distribution of the crystalline quartz ranges from 0 to 8 mm. Beside of 2.5 M-% titanium dioxide which is added for staining the semi-transparent binding material 24, the mineral matter 22 of the surface layer 14 exclusively consists of crystalline crushed quartz. The binding material 24 of the surface layer 14 as shown here is a colorable (colorable means that the binding material 24 itself can be stained) and substantially colorless polymer-modified binding material having the trade name Mexphalte CP2 (Deutsche Shell GmbH) (shown in Table 12). By staining with TiO₂, it obtains a white coloration, providing, together with the bright quartz 22, a very bright asphalt of high reflectivity. The volume percentage of the void 26 in the surface layer 14 is 2.0-4.0 V-%. A stabilizing additive 26 further indicated in FIG. 1 is a filled thermoplastic polyolefin having the trade name PR-Plast.S (Company: Produit Rout Industrie, Genlis) (shown in Table 13). The stabilizing additive is produced as black lentil-like granulate having a graining of 4 mm, and is mixed to the mineral matter which has been heated at processing temperature. In the asphalt the stabilizing additive results in adhesion spots of the mineral grains 22. By these support sites, a high internal friction of the mineral mixture and, at the same time, a good coldness behavior of the asphalt layer is achieved. According to an embodiment not shown in the figures, the binding layer 12 likewise contains a stabilizing additive of PR-Plast.S.

TABLE 1
Asphalt binding layer 0/16 S (Example 1-1)

| General | Specific | Highly durable asphalt binding layer for specific loads | | | | | |
|---|---|---|---|---|---|---|---|
| information | features | | | | | | |
| | Construction | SV, I-III according to German RStO 01 | | | | | |
| | class | | | | | | |
| | Mounting | 9.0-10.0 cm | | | | | |
| | thickness | | | | | | |
| Mixture | Mineral | Kind | Crystalline crushed quartz (supplied by: | | | | |
| composition | matters | | Mitteldeutsche Hartstein-, Kies- und | | | | |
| | | | Mischwerke Naumburg) | | | | |
| | | Grain size | Quartz high | 11/16 | mm | 35.0 | M-% |
| | | distribution | quality | 8/11 | mm | 15.0 | M-% |
| | | | chippings | 5/8 | mm | 9.0 | M-% |
| | | | | 2/5 | mm | 14.0 | M-% |
| | | | Quartz high | 0.71/2 | mm | 7.0 | M-% |
| | | | quality | 0.25/0.71 | mm | 8.0 | M-% |
| | | | crushed | 0.09/0.25 | mm | 6.0 | M-% |
| | | | sand | | | | |
| | | | Quartz dust | <0.09 | mm | 6.0 | M-% |

| Binding | Kind | Polymer-modified binder (Caribit 25 | | |
|---|---|---|---|---|
| material | | supplied by German Shell) | | |
| | Content | | # 4.2-5.5 | M-% |

| Asphalt | General | Compression degree | | ≧97.0% | |
|---|---|---|---|---|---|
| specification | | Void content | | 4.0-7.0 | V-% |
| | | Bulk density | | ≧2.240 | g/cm³ |
| | Mechanical | Crack tensile strength | 20° C. | ≧1.9 | N/mm² |
| | | Resilient Modulus | 40° C. | ≧1300.0 | N/mm² |
| | | | 55° C. | ≧540.0 | N/mm² |

| | | |
|---|---|---|
| Poisson's ratio | 40° C. | Approx. 0.1 |
| | 55° C. | Approx. 0.1 |

| | | | |
|---|---|---|---|
| Thermal | Thermal conductivity | ≧3.0 | W/(m · K) |
| | Specific thermal capacity | 950.0 | J/(kg · K) |

# related to the initial total weight

TABLE 2
Asphalt surface layer of stone mastic asphalt SMA 0/8 S (Example 1-2)

| General | Specific | Use of cellulose fibers and Polyolefines as stabilizing | | | | | |
|---|---|---|---|---|---|---|---|
| information | features | additives; bright-colored binding material | | | | | |
| | Construction | SV, I-III according to German RStO 01 | | | | | |
| | class | | | | | | |
| | Mounting | 2.0-3.0 cm | | | | | |
| | thickness | | | | | | |
| Mixture | Mineral | Kind | Crystalline crushed quartz (supplied by: | | | | |
| composition | matters | | Mitteldeutsche Hartstein-, Kies- und | | | | |
| | | | Mischwerke Naumburg) | | | | |
| | | Grain size | Quartz high | 5/8 | mm | 60.0 | M-% |
| | | distribution | quality | 2/5 | mm | 15.0 | M-% |
| | | | chippings | | | | |
| | | | Quartz high | 0.71/2 | mm | 4.0 | M-% |
| | | | quality | 0.25/0.71 | mm | 4.0 | M-% |
| | | | crushed | 0.09/0.25 | mm | 5.0 | M-% |
| | | | sand | | | | |
| | | | Quartz dust | <0.09 | mm | 9.5 | M-% |
| | | | TiO₂ | <0.09 | mm | 2.5 | M-% |

| Binding | Kind | Polymer-modified binder (Mexphalte CP2, | | |
|---|---|---|---|---|
| material | | supplied by German Shell) | | |
| | Content | | # 6.0-7.0 | M-% |

| | Stabilizing | 0.3 M-% cellulose fibers (Technocel) # | | | |
|---|---|---|---|---|---|
| | additive | 0.6 M-% filled polyolefine (PR-Plast.S, supplied by | | | |
| | | Produit Route Industrie, Genlis) § | | | |
| Asphalt | General | Compression degree | | ≧97.0% | |
| specification | | Void content | | 3.0-4.0 | V-% |
| | | Bulk density | | ≧2.280 | g/cm³ |
| | Mechanical | Crack tensile strength | 20° C. | ≧2.0 | N/mm² |
| | | Resilient Modulus | 40° C. | ≧1050.0 | N/mm² |
| | | | 55° C. | ≧280.0 | N/mm² |

| | | |
|---|---|---|
| Poisson's ratio | 40° C. | Approx. 0.4 |
| | 55° C. | Approx. 0.3 |

| | | | |
|---|---|---|---|
| Thermal | Reflectivity | ≧26% | |
| | Thermal conductivity | ≧2.80 | W/(m · K) |
| | Specific thermal capacity | 750.0 | J/(kg · K) |

# related to the initial total weight,
§ related to the initial total weight minus contents of the binding material and cellulose fibers

TABLE 3
Asphalt surface layer of stone mastic asphalt SMA 0/8 S (Example 1-3)

| General | Specific | Use of cellulose fibers and Polyolefines as stabilizing | | | | | |
|---|---|---|---|---|---|---|---|
| information | features | additives; brighten up by abrasive surface treatment | | | | | |
| | Construction | SV I-III according German RStO 01 | | | | | |
| | class | | | | | | |
| | Mounting | 2.0-3.0 cm | | | | | |
| | thickness | | | | | | |
| Mixture | Mineral | Kind | Crystalline crushed quartz (supplied by: | | | | |
| composition | matters | | Mitteldeutsche Hartstein-, Kies- und | | | | |
| | | | Mischwerke Naumburg) | | | | |
| | | Grain size | Quartz high | 5/8 | mm | 60.0 | M-% |
| | | distribution | quality | 2/5 | mm | 15.0 | M-% |
| | | | chippings | | | | |
| | | | Quartz high | 0.71/2 | mm | 4.0 | M-% |
| | | | quality | 0.25/0.71 | mm | 4.0 | M-% |
| | | | crushed | 0.09/0.25 | mm | 5.0 | M-% |
| | | | sand | | | | |
| | | | Quartz dust | <0.09 | mm | 12.0 | M-% |

| Binding | Kind | Polymer-modified binder (Caribit 45, | | |
|---|---|---|---|---|
| material | | supplied by German Shell) | | |
| | Content | | # 6.0-7.0 | M-% |

| | Stabilizing | 0.3 M-% cellulose fibers (Technocel) # | | | |
|---|---|---|---|---|---|
| | additives | 0.6 M-% filled polyolefines (PR-Plast.S) § | | | |
| Asphalt | General | Compression degree | | ≧97.0% | |
| specification | | Void content | | 3.0-4.0 | V-% |
| | | Bulk density | | ≧2.240 | g/cm³ |
| | Mechanical | Crack tensile strength | 20° C. | ≧2.4 | N/mm² |
| | | Resilient Modulus | 40° C. | ≧1400.0 | N/mm² |
| | | | 55° C. | ≧390.0 | N/mm² |

| | | |
|---|---|---|
| Poisson's ratio | 40° C. | Approx. 0.1 |
| | 55° C. | Approx. 0.1 |

| | | | |
|---|---|---|---|
| Thermal | Reflectivity | ≧17% | |
| | Thermal conductivity | ≧2.80 | W/(m · K) |
| | Specific thermal capacity | 750.0 | J/(kg · K) |

# related to the initial total weight,
§ related to the initial total weight minus contents of binding material and cellulose fibers

### EXAMPLE 2

In the following, further embodiments are explained. Example 2 includes Examples 2-1 to 2-3. In Tables 4-6, the compositions and material characteristics are summarized. In addition, in Tables 4 to 6 the weight content M-% of each component is calculated by M-% related to the total weight of all mixture components (mineral matters, binding materials, and stabilizing additives), which is different from Tables 1-3.

### EXAMPLE 2-1

Table 4 shows a compilation of the composition and material characteristics of an asphalt binding layer. In the table, Microsil (Trademark of Euroquartz Co., Germany) means crystalline quartz dust containing 99.5% of SiO₂ (Silica) (shown in Table 14). Quartz crushed stone and quartz sand are likewise crystalline quartz. Quartz high quality chippings and quartz high quality crashed sand are collected and separated according to the grain sizes at a mine and used at a plant. Microsil is processed at the factory and strictly selected in virtue of the ingredients.

TABLE 4
Asphalt binding layer (Example 2-1)

| Mixture | Mineral | Kind | Crystalline crushed quartz | | | | |
|---|---|---|---|---|---|---|---|
| composition | matters | Grain size | Quartz | 11.2/16.0 | mm | 33.3 | M-% |
| | | distribution | crushed | 8.0/11.2 | mm | 14.3 | M-% |
| | | | stone | 4.0/8.0 | mm | 9.5 | M-% |
| | | | | 2.0/4.0 | mm | 12.4 | M-% |
| | | | Quartz sand | 1.0/2.0 | mm | 6.7 | M-% |
| | | | | 0.50/1.0 | mm | 5.3 | M-% |
| | | | | 0.25/0.50 | mm | 2.3 | M-% |
| | | | | 0.125/0.25 | mm | 3.0 | M-% |
| | | | Microsil | 40/300 | μm | 8.4 | M-% |
| | | | type3 | | | | |
| | | | (Quartz | | | | |
| | | | dust) | | | | |
| | Binding | Kind | Polymer-modified binder (Caribit 25, | | | | |
| | material | | supplied by German Shell) | | | | |
| | | Content | | | | 4.8 | M-% |

| | | | | | |
|---|---|---|---|---|---|
| Asphalt | Mechanical | Crack tensile strength | 20° C. | 2.3 | N/mm² |
| specification | | Resilient Modulus | 40° C. | 1600 | N/mm² |
| | | | 55° C. | 600 | N/mm² |

| | | | |
|---|---|---|---|
| Thermal | Thermal conductivity | 3.5 | W/(m · K) |
| | Specific thermal capacity | 760 | J/(kg · K) |

The binding layer shown in Table 4 was produced by the following operation.

(1) The mineral matters (quartz crushed stone, quartz sand, Microsil) were preheated (at 170° C., for 12 hours or more).
(2) The binding material (Caribit 25) was preheated (at 170° C., for less than 4 hours).
(3) Then, (a) the temperature of the primary materials (mineral matters and binding materials) was maintained, (b) the mineral matters were premixed for 3 minutes with a mixer, (c) the binding material was added, and (d) mixed for 5 minutes.
(4) The asphalt mixture obtained at (3) was again heated at 175° C. for 1 hour.
(5) Marshal samples and a slab were prepared.
(6) Both sides of the Marshal samples were compressed 75 times with a Marshal hammer.
(7) As described above, the slab was compressed.
By the above operation, an asphalt binding layer was obtained.

### EXAMPLE 2-2

Table 5 shows a compilation of the composition and material characteristics of a dark asphalt surface layer.

TABLE 5
Dark asphalt surface layer (Example 2-2)

| Mixture | Mineral | Kind | Crystalline crushed quartz | | | | |
|---|---|---|---|---|---|---|---|
| composition | matters | Grain size | Quartz | 5.0/8.0 | mm | 56.9 | M-% |
| | | distribution | crushed | 2.0/5.0 | mm | 14.3 | M-% |
| | | | stone | | | | |
| | | | Quartz sand | 1.0/2.0 | mm | 3.8 | M-% |
| | | | | 0.50/1.0 | mm | 1.9 | M-% |
| | | | | 0.25/0.50 | mm | 2.4 | M-% |
| | | | Microsil | 40/300 | μm | 13.3 | M-% |
| | | | types | | | | |
| | | | (Quartz | | | | |
| | | | dust) | | | | |

| Binding | Kind | Polymer-modified binder (Caribit 45, | | |
|---|---|---|---|---|
| material | | supplied by German Shell) | | |
| | Content | | 6.5 | M-% |

| | Stabilizing | 0.3 M-% cellulose fibers (Technocel supplied by CFF, | | | |
|---|---|---|---|---|---|
| | additives | Germany) | | | |
| | | 0.6 M-% filled polyolefines (PR-Plast S-) | | | |
| Asphalt | Mechanical | Crack tensile strength | 20° C. | 2.7 | N/mm² |
| specification | | Resilient Modulus | 40° C. | 1800.0 | N/mm² |
| | | | 55° C. | 550.0 | N/mm² |

| | | | |
|---|---|---|---|
| Thermal | Reflectivity | 10% | |
| | Thermal conductivity | 3.2 | W/(m · K) |
| | Specific thermal capacity | 940 | J/(kg · K) |

The dark asphalt surface layer according to Table 5 was produced by the following operation.

(1) The mineral matters (quartz crushed stone, quartz sand, Microsil) were preheated (at 175° C., for 12 hours or more).
(2) The binding material (Caribit 45) was preheated (at 170° C., for less than 4 hours).
(3) The stabilizing additive (Technocel) and stabilizing additive (PR-Plast.S) were preheated at room temperature of 23° C.
(4) The stabilizing additive (Technocel) was added to the binding material (Caribit 45), and premixed.
(5) The mixture (binding material (Caribit 45)+stabilizing additive (Technocel)) was again heated at 175° C. for less than 12 hours.
(6) The stabilizing additive (PR-Plast.S) was added to the above mineral matters and premixed.
(7) The mixture (binding material (Caribit 45)+stabilizing additive (Technocel)) was added to the mineral matters (quartz crushed stone, quartz sand, Microsil)+stabilizing additive (PR-Plast.S)).
(8) This mixture was mixed by hand for 5 minutes.
(9) The asphalt mixture (quartz crushed stone, quartz sand, Microsil+stabilizing additive (PR-Plast.S)+binding material (Caribit 45)+stabilizing additive (Technocel)) was heated again at 175° C. for one hour.
(10) Marshal samples and a slab were prepared (in this preparation, the mixing temperature was above 160° C.).
(11) Both sides of the Marshal samples were compressed for 75 times with a Marshal hammer (after the compression, the temperature was above 110° C.).
(12) Based on the bulk density, the slab was compressed.
By the above operation, a dark asphalt surface layer was obtained. The binding material (PR-Plast.S) is a dark binding material as shown in Table 13. Accordingly, in the case of this example, it is recommended to remove films of the dark binding material by an abrasive surface treatment of the light-colored mineral matters. In this way, the reflectivity is improved.

### EXAMPLE 2-3

Table 6 shows the composition of a light-colored asphalt surface layer and the characteristics of the materials.

TABLE 6
Liqht-colored asphalt surface layer (Example 2-3)

| Mixture | Mineral | Kind | Crystalline quartz | | | | |
|---|---|---|---|---|---|---|---|
| composition | matters | Grain size | Quartz | 5.0/8.0 | mm | 55.6 | M-% |
| | | distribution | crushed | 2.0/5.0 | mm | 13.9 | M-% |
| | | | stone | | | | |
| | | | Quartz | 1.0/2.0 | mm | 3.7 | M-% |
| | | | sand | 0.50/1.0 | mm | 1.8 | M-% |
| | | | | 0.25/0.50 | mm | 2.3 | M-% |
| | | | Microsil | 40/300 | μm | 13.0 | M-% |
| | | | type3 | | | | |
| | | | (Quartz | | | | |
| | | | dust) | | | | |
| | | | TiO₂ | <0.09 | mm | 2.3 | M-% |

| Binding | Kind | Polymer-modified binder (Mexphalte CP2, | | |
|---|---|---|---|---|
| material | | supplied by Shell, Germany) | | |
| | Content | | 6.5 | M-% |

| | Stabilizing | 0.3M-% cellulose fibers (Technocel supplied by CFF, | | | |
|---|---|---|---|---|---|
| | additives | Germany) | | | |
| | | 0.6M-% filled polyolefines (PR-Plast.S) | | | |
| Asphalt | Mechanical | Crack tensile strength | 20° C. | 2.2 | N/mm² |
| specification | | Resilient Modulus | 40° C. | 1200 | N/mm² |
| | | | 55° C. | 260 | N/mm² |

| | | | |
|---|---|---|---|
| Thermal | Reflectivity | 23% | |
| | Thermal conductivity | 3.2 | W/(m · K) |
| | Specific thermal capacity | 940 | J/(kg · K) |

The light-colored asphalt surface layer was produced by the following operation.

(1) The mineral matters (quartz crushed stone, quartz sand, Microsil) were preheated (at 175° C., for 12 hours or more).
(2) The binding material (Mexphalte CP2) was preheated (at 170° C., for less than 4 hours).
(3) The light-colored pigment (titanium dioxide) and the stabilizing additive (Technocel) were preheated at room temperature of 23° C.
(4) The light-colored pigment (titanium dioxide) was added to the binding material (Mexphalte CP2) and premixed.
(5) The mixture was heated again at 175° C. for 5 hours.
(6) The stabilizing additive (Technocel) was added to the binding material ((Mexphalte CP2)+light-colored pigment (titanium dioxide)) and premixed.
(7) The prepared binding mixture (binding material (Mexphalte CP2)+light-colored pigment (titanium dioxide)+stabilizing additive (Technocel)) was again heated at 175° C. for less than 2 hours.
(8) The stabilizing additive (PR-Plast.S) was added to the mineral matters (quartz crushed stone, quartz sand, Microsil) and the mixture was preheated.
(9) The prepared binding mixture (binding material (Mexphalte CP2)+light-colored pigment (titanium dioxide)+stabilizing additive (Technocel)) was added into mineral matters (quartz crushed stone, quartz sand, Microsil+stabilizing additive (PR-Plast.S)).
(10) The mixture was mixed by hand for 5 minutes.
(11) The asphalt mixture (mineral matters (quartz crushed stone, quartz sand, Microsil+stabilizing additive (PR-Plast.S)+binding material (Mexphalte CP2)+light-colored pigment (titanium dioxide)+stabilizing material (Technocel)) was heated again at 175° C. for one hour.
(12) Marshal samples and a slab were prepared (in this preparation, the mixing temperature was above 160° C.).
(13) Both sides of Marshal samples were compressed for 75 times with a Marshal hammer (after the compression, the temperature was above 110° C.).
(14) Based on the bulk density, the slab was compressed.
By the above operation, a light-colored asphalt surface layer was obtained.

(Evaluation Test)

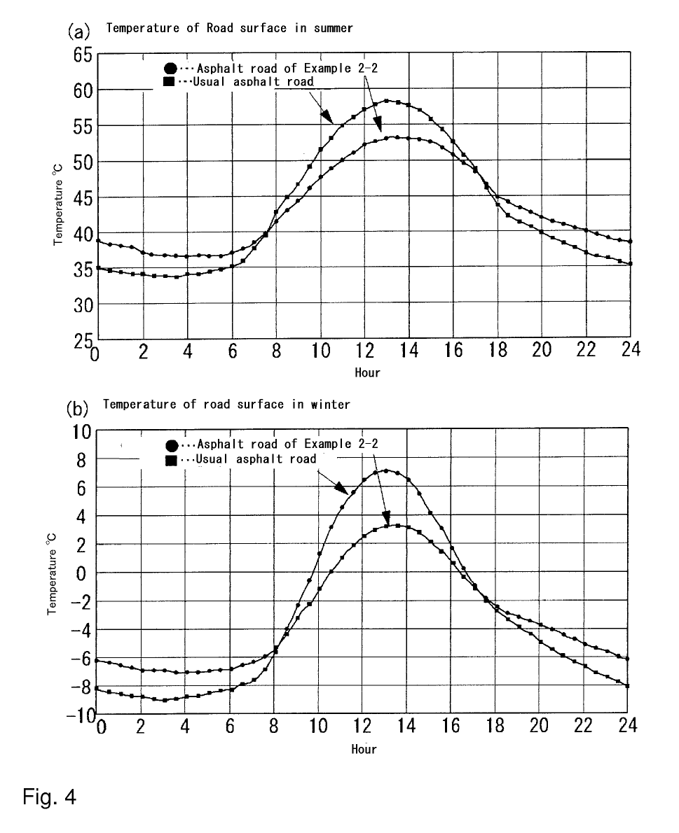

The temperatures of the road surfaces of the asphalt pavement according to Example 2-2 and of a conventional asphalt pavement were compared. The results are shown in FIGS. 4 (a) and (b). FIG. 4(a) shows the temperature change in summer, and FIG. 4(b) shows the temperature change in winter. In the figures, the points denote temperatures of the road surface of the asphalt pavement of Example 2-2, and the points ▪ denote the temperatures of the road surface of the conventional asphalt pavement. As it is apparent from these figures, the asphalt pavement of Example 2-2 reduces the temperature rise by about 5° C. at the highest temperatures in summer, and the temperature drop by about 4° C. at the lowest temperatures in winter. Furthermore, the temperature change during a day according to the temperature difference of the asphalt pavement of Example 2-2 is smaller than that of the conventional asphalt pavement. Accordingly, the road pavement of this invention is less affected by the temperature difference than the conventional asphalt road, so that it is suitable for counteracting the heat island phenomenon in summer and for protection the road from freezing in winter.

### EXAMPLE 3

Example 3 includes Examples 3-1 to 3-3. In Tables 7-9, the composition and material characteristics are summarized. In addition, in Tables 7 to 9 “total weight” means total weight of the mineral matters (except TiO₂) as in Tables 1-3. Accordingly, the weight of the binding materials, the stabilizing additives and of TiO₂ is represented as M-% related to 100 M-% of mineral matters.

### EXAMPLE 3-1

Table 7 shows a compilation of the composition and material characteristics of the asphalt binding surface layer. In the table, although silica is used as a mineral matter, this silica contains 93 M-% or more of silicon dioxide (SiO₂). Silica is collected in a mine and separated according to the grain size and used at a plant.

TABLE 7
Asphalt binding layer (Example 3-1)

| Mixture | Mineral | Kind | Silica | | | | |
|---|---|---|---|---|---|---|---|
| composition | matters | Particle size | Silica | 13.0/20.0 | mm | 25.0 | M-% |
| | | distribution | crushed | 5.0/13.0 | mm | 32.0 | M-% |
| | | | stone | 2.5/5.0 | mm | 14.0 | M-% |
| | | | Silica | 0.0/2.5 | mm | 23.0 | M-% |
| | | | crushed | | | | |
| | | | stone and | | | | |
| | | | silica sand | | | | |
| | | | Silica | 0.0/2.5 | mm | 6.0 | M-% |
| | | | crushed | | | | |
| | | | dust | | | | |

| Binding | Kind | Polymer-modified binder (Caribit 25, | | |
|---|---|---|---|---|
| material | | supplied by Shell, Germany) | | |
| | Content | | # 5.0 | M-% |

| | |
|---|---|
| Stabilizing | 0.6 M-% filled polyolefines (PR-Plast S) # |
| additive | |

# related to the initial total weight

The asphalt binding layer according to Table 7 was produced by the following operation.

(1) The mineral matters (silica crushed stone, silica sand, silica crushed dust) were preheated (at 170, for 12 hours or more).
(2) The binding material (Caribit 25) was preheated (at 170° C., for less than 4 hours).
(3) Then, (a) the temperature of the primary materials (mineral matters and binding material) was maintained, (b) the mineral matters were premixed for 3 minutes with a mixer, (c) the binding material was added, and (d) mixed for 5 minutes.
(4) The asphalt mixture obtained at (3) was again heated at 175° C. for 1 hour.
(5) Marshal samples and a slab were prepared.
(6) Both sides of the Marshal samples were compressed for 75 times with a Marshal hammer.
(7) As described above, the slab was compressed.
By the above operation, the asphalt binding layer was obtained.

### EXAMPLE 3-2

Table 8 shows a compilation of the composition and material characteristics of a dark asphalt surface layer.

TABLE 8
Dark-colored asphalt surface layer (Example 3-2)

| Mixture | Mineral | Kind | Silica | | | | |
|---|---|---|---|---|---|---|---|
| composition | matters | Grain size | Silica | 5.0/8.0 | mm | 64.0 | M-% |
| | | distribution | crushed | 2.5/5.0 | mm | 13.0 | M-% |
| | | | stone | | | | |
| | | | Silica | 0.0/2.5 | mm | 9.0 | M-% |
| | | | crushed | | | | |
| | | | stone and | | | | |
| | | | Silica sand | | | | |
| | | | Silica | 0.0/2.5 | mm | 14.0 | M-% |
| | | | crushed | | | | |
| | | | dust | | | | |

| Binding | Kind | Polymer-modified binder (Caribit 45, | | |
|---|---|---|---|---|
| material | | supplied by Shell, Germany) | | |
| | Content | | # 6.5 | M-% |

| | |
|---|---|
| Stabilizing | 0.3 M-% cellulose fibers (SMA abocel supplied by |
| additives | Clariant Polymer, Germany) # |
| | 0.6 M-% filled polyolefines (PR-Plast.S) # |

# related to the initial total weight

The dark asphalt surface layer according to Table 8 was produced by the following operation. In the table, although silica is used as a mineral material, this silica contains 93 M-% or more of silicon dioxide (SiO₂). Silica is collected in a mine and separated according to the grain size and used at a plant.

(1) The mineral matters (silica crushed stone, silica sand, silica dust) were preheated (at 170° C., for 12 hours or more).
(2) The binding material (Caribit 25) was preheated (at 170° C., for less than 4 hours).
(3) The stabilizing additive (SMA Abocel) and the stabilizing additive (PR-Plast.S) were heated at room temperature of 23° C.
(4) The stabilizing additive (SMA Abocel) was added to the binding material (Caribit 25) and premixed.
(5) The mixture (binding material (Caribit 25)+stabilizing additive (SMA Abocel)) was heated again at 175° C. for less than 2 hours.
(6) The stabilizing material (PR-Plast.S) was added to the mineral matters and premixed.
(7) The mixture (binding material (Caribit 45)+stabilizing additive (SMA Abocel)) was added to the mineral matters (silica crushed stone, silica sand, silica dust+stabilizing additive (PR-Plast.S)).
(8) The mixture was mixed by hand for 5 minutes.
(9) The asphalt mixture (silica crushed stone, silica sand, silica dust+stabilizing material (PR-Plast.S)+binding material (Caribit 45)+stabilizing additive (SMA Abocel)) was heated again at 175° C. for less than 1 hour.
(10) Marshal samples and a slab were prepared (in this preparation, the mixing temperature was above 160° C.).
(11) Both sides of the Marshal samples were compressed for 75 times with a Marshal hammer (after the compression, the temperature was above 110° C.).
(12) Based on the bulk density, the slab was compressed.
By the above operation, a dark-colored asphalt surface layer was obtained. The binding material (PR-Plast.S) is a dark binding materials as shown in Table 13. Accordingly, for increasing the reflectivity, the light-colored mineral matter may be sandblasted to remove the film of dark-colored binding materials.

### EXAMPLE 3-3

Table 9 shows a compilation of the composition and material characteristics of a light-colored asphalt surface layer. In the table, although silica is used as mineral matter, this silica contains 93 M-% or more of silicon dioxide (SiO₂). Silica is collected in a mine and separated according to the grain size and used at a plant.

TABLE 9
Light-colored asphalt surface layer (Example 3-3)

| Mixture | Mineral | Kind | Silica | | | | |
|---|---|---|---|---|---|---|---|
| composition | matters | Grain size | Silica | 5.0/8.0 | mm | 64.0 | M-% |
| | | distribution | crushed | 2.5/5.0 | mm | 13.0 | M-% |
| | | | stone | | | | |
| | | | Silica | 0.0/2.5 | mm | 9.0 | M-% |
| | | | crushed | | | | |
| | | | stone and | | | | |
| | | | Silica sand | | | | |
| | | | Silica | 0.0/2.5 | mm | 14.0 | M-% |
| | | | crushed | | | | |
| | | | dust | | | | |
| | | | TiO₂ | | | 2.5 | M-% |

| Binding | Kind | Polymer-modified binder (Mexphalte CP2, | | |
|---|---|---|---|---|
| material | | supplied by Shell, Germany) | | |
| | Content | | # 6.5 | M-% |

| | |
|---|---|
| Stabilizing | 0.3 M-% cellulose fibers (SMA Abocel, supplied by |
| additives | Clariant Polymer, Germany) # |
| | 0.6 M-% filled polyolefines (PR-Plast S) # |

# related to the initial total weight

The light-colored asphalt surface layer shown in Table 9 was produced by the following operation.

(1) The mineral matter (silica crushed stone, silica sand, silica dust) were preheated (at 170° C., for 12 hours or more).
(2) The binding material (Mexphalte CP2) was preheated (at 175° C., for less than 4 hours).
(3) The light-colored pigment (titanium dioxide) and the stabilizing additive (SMA Abocel) were heated at room temperature of 23° C.
(4) The light-colored pigment (titanium dioxide) was added to the binding material (Mexphalte CP2) and premixed.
(5) The mixture was heated again at 175° C. for 0.5 hours.
(6) The stabilizing additive (SMA Abocel) was added to the binding material mixture (binding material (Mexphalte CP2)+light-colored pigment (titanium dioxide)) and premixed.
(7) The prepared binding material mixture (binding material (Mexphalte CP2)+light-colored pigment (titanium dioxide)+stabilizing additive (SMA Abocel)) were again heated at 175° C. for less than 2 hours or less.
(8) The stabilizing additive (PR-Plast.S) was added to the mineral matters (silica crushed stone, silica sand, silica dust) and the mixture was preheated.
(9) The prepared binding materials (binding material (Mexphalte CP2)+light-colored pigment (titanium dioxide)+stabilizing additive (SMA Abocel)) were added to the mineral matters (silica crushed stone, silica sand, silica dust+stabilizing additive (PR-Plast.S)).
(10) The mixture was mixed by hand for 5 minutes.
(11) The asphalt mixture (mineral matters (silica crushed stone, silica sand, silica dust+binding material (Mexphalte CP2)+light-colored pigment (titanium dioxide)+stabilizing additive (SMA Abocel)) was heated again.
(12) Marshal samples and a slab were prepared (in this preparation, the mixing temperature was above 160° C.).
(13) Both sides of the Marshal samples were compressed for 75 times with a Marshal hammer (after the compression, the temperature was above 110° C.).
(14) Based on the bulk density, the slab was compressed.
By the above operation, a light-colored asphalt surface layer was obtained.

(Evaluation Test)

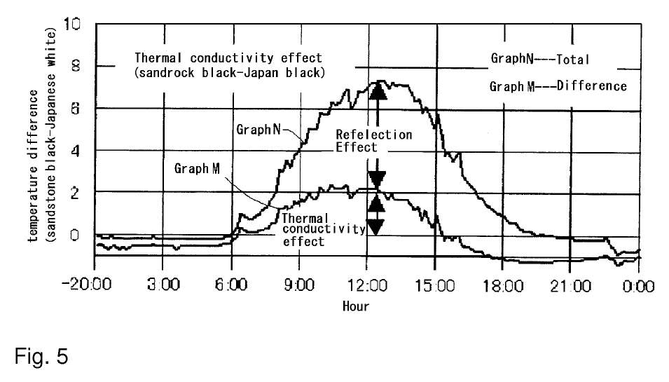

Referring to FIG. 5, the evaluation test (a test for measuring temperatures) is described. This evaluation test (test for measuring temperatures) was conducted with an asphalt roadway pavement comprising the binding layer according to Example 3-1 and a surface layer according to Example 3-3. The test method for measuring the temperatures is shown in the following. First as a comparative standard, a temperature sensor a was inserted into an area of the binding layer of a conventional asphalt (having black sand stone as main ingredient), and 2 cm above, temperature sensor b was inserted into the surface layer. Then as test object, temperature sensor A was inserted into an area of the binding layer of the asphalt roadway pavement, comprising the binding layer according to Example 3-1 and the surface layer according to Example 3-3, and at an area 2 cm above, temperature sensor B was inserted into the surface layer.

Then, the differences of temperature sensor a and temperature sensor A ((temperature indicated by temperature sensor a)−(temperature indicated by temperature sensor A)), and the differences of temperature sensor b and temperature sensor B ((temperature indicated by temperature sensor b)−(temperature indicated by temperature sensor B)) were determined during one day from 0:00 AM to 12:00 PM. In FIG. 5, graph M shows the differences of the temperatures between temperature sensor a and temperature sensor A, and graph N shows the differences of the temperatures between temperature sensor b and temperature sensor B.

Moreover, during the test hours from around 6:00 AM to around 4:00 PM, since the temperatures of the temperature sensor A were lower than the temperatures of the temperature sensor a (i.e. the temperatures of the conventional sand rock (black sand rock) were higher), it is confirmed that the temperature rise of the asphalt layer according to Example 3-1 was reduced in the daytime at comparable high temperatures. The highest temperature difference was about 2° C. Thus, the asphalt binding layer according to Example 3-1 could reduce the temperature rise compared to the asphalt binding layer of sand rock (black sand rock). The reason is that, due to the use of silica instead of conventional sand rock as asphalt construction substance, a more efficient heat conduction from the surface to the underground was obtained.

On the other hand, at the surface area, namely, at the part irradiated directly by the sunlight, the differences of temperature sensor b and temperature sensor B were determined. During the test hours from around 6:00 AM to around 8:00 PM, since the temperatures of temperature sensor B were lower than the temperatures of temperature sensor b (i.e. the temperatures of the conventional sand rock (black sand rock) were higher), it is confirmed that the temperature rise of the asphalt layer according to Example 3-3 was further notably suppressed. The highest temperature difference was about 8° C. Thus, the asphalt surface layer according to Example 3-3 could reduce the temperature rise compared to the asphalt surface layer of sand rock (black sand rock). The reason is that, due to the use of silica instead of the conventional sand rock as asphalt construction substance, the albedo (reflectivity of the sunlight) on the surface was increased, and that more efficient heat conduction from the surface to the underground was obtained.

The effects of the heat conductivity correspond to the temperature differences of the binding layers, and the reflectivity of the sunlight correspond to the differences of the temperature differences of the surface layer minus the temperature differences of the binding layer (shown in FIG. 5). Since the sun does not shine on the binding layer area, the temperature differences of the binding layer result from the differences of the effects of the thermal conductivity.

As described the above, the asphalt pavement 10 of Examples 1-3 is characterized by the following properties:

1. By using light-colored mineral matter and light-stained binding material (or alternatively, in case of employing dark binding materials, by abrasive surface treatment for removing the film of binding material from the bright mineral matters), the surface reflectivity of surface layer 14 is high.
2. Due to the high heat conductivity of quartz, the heat permeability property is high.
3. High resilient modulus, low plastic deformability and high thickness of the bending resistant binding layer result in high flexural rigidity.
4. Due to employment of quartz and polymer-modified binding material as well as to a sufficiently high void content for heat expansion of the binding material, the thermal expansion coefficient is low.

In the following, important data of the materials used in this invention are shown. Tables 10 and 11 show the norm values according to TL-PmB2002 along with typical values of Caribit 25 and Caribit 45 supplied by Shell Co., Germany (Caribit 25 corresponds to PmB25A type and Caribit 45 corresponds to PmB45A type) that were used as binding materials. Table 12 shows norm values and typical values of Mexphalte CP2 of Shell Co., Germany that was used as binding material. Table 13 shows norm values and typical values of PR-Plast.S of Produit Route Co. that was used as stabilizing additive. Table 14 shows the average grain size distribution, a chemical assay and characteristic values of Microsil type 3 of Euroquartz Co. Germany that was used as mineral matter.

TABLE 10
Caribit 25
Polymer-modified bitumen in conformity with TL PmB 2001
Norm values and typical values

| | | Typical | |
|---|---|---|---|
| | Norm values | values | Test method |
| Penetration (25° C.) 0.1 mm | 10-40 | 25 | EN 1426 |
| Softening point (Ring ball test) ° C. | 63-71 | 68 | EN 1427 |
| Braking point ° C. | max. −5 | −10 | EN 12 593 |
| Ductility (25° C.) cm | min. 20 | 45 | DIN 52 013 |
| Density (25° C.) g/cm³ | 1.00-1.10 | 1.03 | DIN 52 004 |
| Flashpoint ° C. | min. 235 | 300 | EN 22 592 |
| Elastic recovery % | min. 50 | 57 | DIN V 52 021-1 |
| Storage stability (180° C. 3 d) | | | TL-PmB 2001 |
| Change of softening point (Ring ball | Max. 2.0 | 0.0 | |
| test (R & B)) | | | |
| Hardening resistance (RTFOT or RFT) | | | EN 12607-3 |
| Change of mass % | Max. 0.5 | 0 | |
| Change of Softening point (R & B) | | | |
| increase ° C. | Max. 8.0 | 6.0 | EN 1427 |
| decrease ° C. | Max. 2.0 | — | |
| Change of penetration remaining % | Min. 60 | 75 | EN 1426 |
| increase % | Max. 10 | — | |
| Ductility (25° C.) cm | Min. 10 | 18 | DIN 52 013 |
| Elastic recovery % | Min. 50 | 55 | DIN V 52 021-1 |
| BBR Stiffness (−16° C.) MPa | Max. 350 | 310 | AASHTO TP-1 |
| DSR Complex elastic modulus G | Min. 15000 | 21000 | AASHTO TP-5 |
| (60° C.) Pa | | | |
| DSR phase angle δ (60° C.) ° | Max. 70 | 67 | AASHTO TP-5 |

TABLE 11
Caribit 45
Polymer-modified bitumen in conformity with TL PmB 2001
Norm values and typical values

| | | Typical | |
|---|---|---|---|
| | Norm values | values | Test method |
| Penetration (25° C.) 0.1 mm | 20-60 | 30 | EN 1426 |
| Softening point (Ring ball test) ° C. | 55-63 | 60 | EN 1427 |
| Braking point ° C. | max. −10 | −14 | EN 12 593 |
| Ductility (25° C.) cm | min. 40 | 80 | DIN 52 013 |
| Density (25° C.) g/cm³ | 1.00-1.10 | 1.03 | DIN 52 004 |
| Flash point ° C. | min. 235 | 300 | EN 22 592 |
| Elastic recovery % | min. 50 | 57 | DIN V 52 021-1 |
| Storage stability (180° C. 3 d) | | | TL-PmB 2001 |
| Change of softening point (Ring ball | max. 2 | 0.0 | |
| test (R & B)) | | | |
| Hardening resistance (RTFOT or RFT) | | | EN 12607-3 |
| Change of mass % | Max. 0.5 | 0 | |
| Change of Softening point (R & B) | Max. 8.0 | 5.0 | EN 1427 |
| increase ° C. | Max. 2.0 | — | |
| decrease ° C. | Min. 60 | 75 | EN 1426 |
| Change of penetration remaining % | Max. 10 | — | |
| increase % | Min. 50 | 65 | DIN 52 013 |
| Ductility (25° C.) cm | Min. 50 | 55 | DIN V 52 021-1 |
| Elastic recovery % | | | |
| BBR Stiffness (−16° C.) MPa | Max. 300 | 250 | AASHTO TP-1 |
| DSR Complex elastic modulus G | Min. 7000 | 9500 | AASHTO TP-5 |
| (60° C.) Pa | | | |
| DSR phase angle δ (60° C.) ° | Max. 75 | 70 | AASHTO TP-5 |

TABLE 12
Mexphalte C P2
Polymer-modified colored binder
Norm values and typical values

| | | Typical | |
|---|---|---|---|
| | Norm value | values | Method of tests |
| Penetration (25° C.) 0.1 mm | 35-45 | 35 | DIN EN 1426 |
| Softening point (Ring ball test) ° C. | 54-60 | 58 | DIN EN 1427 |
| Density (25° C.) g/cm³ | 1.0-1.1 | 1.008 | DIN 52 004 |
| Solubility wt. % | Min. 99 | 99.8 | DIN EN 12 592 |
| Breaking point ° C. | max. −15 | −16 | DIN EN 12 593 |
| Flash point (open cup) ° C. | min. 230 | 250 | DIN EN 22 592 |
| Ductility (25° C.) cm | min. 60 | 100 | DIN 52 013 |
| Force ductility: energy to 20 cm J | | 0.98 | prEN 13 589 |
| Force ductility: energy to rupture J | | 8.59 | prEN 13 589 |
| Elastic recovery % | min. 50 | 90 | DIN 52 021 |
| Storage stability (180° C. 3 d) | | | TL-PmB 2001 |
| Change in softening point (Ring ball | Max. 2 | 0.0 | |
| test (R & B)) | | | |
| Ageing characteristics | | | DIN EN 12607-3 |
| Change of mass % | Max. 0.5 | 0.05 | |
| Retained Penetration % | Min. 55 | 97 | |
| Change of softening point ° C. | Max. 6.5 | −3.5 | |
| Ductility (25° C.) cm | Min. 40 | 78 | |
| Force ductility: energy to 20 cm J | | 0.74 | |
| Force ductility: energy to rupture J | | 3.16 | |

TABLE 13
Data sheet PR Plast. S

| Characteristic | Value | Unit |
|---|---|---|
| Shape | Black lenticular pellet | |
| Density | 0.91-0.965 | g/cm³ |
| Polyolefine content | 95 | % |
| Filler content | 5 | % |
| Melting point | 140-150 | ° C. |
| Size of particles | 4 | mm |

TABLE 14
Average gain size distribution

| Sieve size (μm) | Remaining percentage (%) | Passing percentage (%) |
|---|---|---|
| 300 | 0 | 100 |
| 250 | 0 | 99 |
| 200 | 2 | 98 |
| 160 | 6 | 94 |
| 100 | 32 | 68 |
| 63 | 56 | 44 |
| 40 | 68 | 32 |
| <40 | 100 | 0 |

Content (M-%)

Chemical assay

| | |
|---|---|
| SiO₂ | >99.5 |
| Al₂O₃ | 0.11 |
| Fe₂O₃ | 0.030 |
| TiO₂ | 0.067 |

Data

| | |
|---|---|
| Bulk density (g/cm³) | 1.3 |
| Density (g/cm³) | 2.65 |
| Mohs hardness | 7 |
| Combustion loss (%) | <0.1 |
| Water (%) | <0.1 |
| Sintering temperature (° C.) | 1575 |
| Specific surface (cm²/g) | 1600 |

Although individual embodiments of this invention are described above, this invention is not limited to the above-mentioned examples. The road pavement of this invention is satisfied when at least 60 M-% of the mineral matter contained in the asphalt layer (namely, the surface layer and the binding layer) is crystalline quartz. As material containing such mineral matters and satisfying such conditions, for example, silica (grains ranging from big aggregates to sands, not containing feldspar) or silica sand (sand of 5 mm or less, feldspar is often contained, otherwise, quartz grains are contained solely) can be used. In this occasion, as the materials of silica or artificial silica sand, chart, quartzite, and quartz parts of quartz piece rocks can be used. Natural silica also can be used.

Instead of the binding materials used in the above embodiments, binding materials are known, which are referred to as modified type 1 and modified type 2 and/or modified type 3 among the persons belonging to this field in Japan, can be used. These binding materials of modified type 1 and modified type 2 and/or modified type 3 can be used in accordance with the desired characteristics of the asphalt, and further, stabilizing additives, binding materials and/or the other modified strengthening materials as used in the above embodiment can be used.

### INDUSTRIAL APPLICABILITY

The roadway pavement of this invention is suitable to reduce the formation of prints from the wheels (rut formation) at high heat and mechanical loads in summer and to reduce longitudinal cracks along ruts in winter, even if these weather conditions are present in the centers of big cities and other urban agglomeration areas.

### REFERENCE NUMBERS

10 road pavement
12 binding layer
14 surface layer
16 mineral matter/crystalline quartz
18 binding materials/polymer-modified bitumen
20 void
22 mineral matters/crystalline quartz
24 binding materials/colorable polymer-modified binding materials
26 void
28 stabilizing additives
M-% mass percentage
V-% volume percentage
d₁ layer thickness of surface layer
d₂ layer thickness of binding layer
b heat penetration coefficient
λ thermal conductivity
ρ dry apparent density (or bulk density)
cₚ specific thermal capacity

1. A road pavement (10) with at least one asphalt layer (12, 14) comprising a mixture of at least one mineral matter (16, 22) and at least one binding material (18, 24), wherein at least 60 M-% of the mineral matter (16, 22) of the at least one asphalt layer (12, 14) is crystalline quartz.

2. The road pavement (10) of claim 1, wherein at least 90 M-%, particularly at least 95 M-%, preferably at least 97 M-% of the mineral matter (22) of the at least one asphalt layer (12,14) is crystalline quartz.

3. The road pavement (10) of claim 1, wherein the crystalline quartz has at least 93 M-% of silicon dioxide (SiO₂) per mass percentage and a melting temperature of at least 1500□.

4. The road pavement (10) of claim 3, wherein the crystalline quartz is crystalline crushed quartz and, particularly, it is a mixture of at least one quartz high quality chippings and at least one quartz high quality crushed sand and quartz dust.

5. The road pavement (10) of claim 1-4, wherein the paved road (10) includes at least two asphalt layers comprising an upper surface layer (14) and an underlying binding layer (12), and the surface layer (14) and/or the binding layer (12) each contain at least 60 M-% of crystalline quartz as mineral matter (16, 22).

6. The road pavement (10) of claim 5, wherein a grain size distribution of the mineral matter in the surface layer (14) is 0-8 mm.

7. The road pavement (10) of claim 6, wherein the mineral matter of the surface layer (14) has the following grain size distribution:
70-80 M-%, particularly about 75 M-% correspond to a grain size range of 2-8 mm;
8-18 M-%, particularly about 13 M-% correspond to a grain size range of 0.09-2 mm; and
7-17 M-%, particularly about 12 M-% correspond to a grain size range of 0-0.09 mm.

8. The road pavement (10) of claim 5, wherein a grain size distribution of the mineral matter of the binding layer (12) is 0-16 mm.

9. The road pavement (10) of claim 8, wherein the mineral matter of the binding layer (12) has the following particle size distribution:
70-80 M-%, particularly about 73 M-% correspond to a particle size range of 2-16 mm;
15-30 M-%, particularly about 21 M-% correspond to a particle size range of 0.09-2 mm; and
3-10 M-%, particularly about 6 M-% correspond to a particle size range of 0-0.09 mm.

10. The road pavement (10) of claim 5, wherein an average mounting thickness (d₁) of the surface layer (14) is in the range of 2.0-3.0 cm, and an average mounting thickness (d₂) of the binding layer (12) is in the range of 8.5-11.0 cm.

11. The road pavement (10) of claim 10, wherein the average mounting thickness (d₁) of the surface layer (14) is about 2.5 cm, and the average mounting thickness (d₂) of the binding layer (12) is about 9.5 cm.

12. The road pavement (10) of claim 1, wherein at least one of the asphalt layers (12, 14) contains a polymer-modified bitumen or a polymer-modified synthetic binding material as binding material (18, 24).

13. The road pavement (10) of claim 12, wherein the binding layer (12) contains a polymer-modified bitumen of type PmB25A as binding material (18).

14. The road pavement (10) of claim 12, wherein the surface layer (14) contains a polymer-modified bitumen of type PmB45A as binding material (24).

15. The road pavement (10) of claim 14, wherein the surface of the surface layer (14) is treated by an erosive treatment that removes a film of binding material, particularly by sandblasting.

16. The paved road pavement (10) of claim 12, wherein the surface layer (14) contains at least one of a light-colored, a transparent, a semi-transparent binding material (24) and/or a binding material (24) colorable with a pigment.

17. The road pavement (10) of claim 16, wherein the surface layer (14) contains a polymer-modified binding material (24) colored with titanium dioxide TiO₂.

18. The road pavement (10) of claim 5, wherein the surface layer (14) and/or the binding layer (12) contains at least one stabilizing additive (28).

19. The road pavement (10) of claim 18, wherein the surface layer (14) contains cellulose fibers and/or a filled polyolefine as stabilizing additive (28).

20. The road pavement (10) of claim 18, wherein the binding layer (12) contains a filled polyolefine as stabilizing additive.

21. The road pavement (10) of claim 5, wherein the surface layer (14) has a void content in the range of 1.0-6.0 V-%, particularly of 2.0-5.0 V-%, preferably of 3.0-4.0 V-%.

22. The road pavement (10) of claim 5, wherein the binding layer (12) has a void content in the range of 2.0-9.0 V-%, particularly of 3.0-8.0 V-%, preferably of 4.0-7.0 V-%.

23. The road pavement (10) of claim 5 with at least two asphalt layers comprising an upper surface layer (14) and an underlying binding layer (12), and the surface layer (14) and/or the binding layer (12) each contain a mixture of at least one mineral matter (16, 22) and at least one binding material (18, 24), wherein the surface layer (14) has the following composition:
80-95 M-% of crystalline crushed quartz (22),
6.0-8.0 M-% of a colorable polymer-modified binding material (24),
0.3-2.0 M-% of at least one stabilizing additive (28) and
0.1-3.0 M-% related to the mineral matter content of a white inorganic pigment.

24. The road pavement (10) of claim 5 with at least two asphalt layers comprising an upper surface layer (14) and an underlying binding layer (12), and the surface layer (14) and/or the binding layer (12) each contain a mixture of at least one mineral matter (16, 22) and at least one binding material (18,24), wherein the surface layer (14) has the following composition:
80-95 M-% of crystalline crushed quartz (22),
6.0-8.0 M-% of a polymer-modified binding material (24), and
0.3-2.0 M-% of at least one stabilizing additive (28),
and the surface of the surface layer (14) is treated by an erosive treatment that removes a film of binding material.

25. The road pavement (10) of claim 5 with at least two asphalt layers comprising an of upper surface layer (14) and an underlying binding layer (12), and the surface layer (14) and/or the binding layer (12) each contain a mixture of at least one mineral matter (16, 22) and at least one binding material (18,24), wherein the binding layer (12) has the following composition:
94-96.5 M-% of crystalline crushed quartz (16) and
3.5-6.0 M-% of a polymer-modified binding material (18).

26. The road pavement (10) of claim 1, wherein silica is used instead of the crystalline quartz.
